(19) United States
(12) Patent Application Publication
(10) Pub. No.: US 2022/0398657 A1
(43) Pub. Date: Dec. 15, 2022

(54) Bill Payment System Partnering Users and Lenders

(71) Applicant: Gezim Ramabaja, Mississauga (CA)

(72) Inventor: Gezim Ramabaja, Mississauga (CA)

(21) Appl. No.: 17/345,442

(22) Filed: Jun. 11, 2021

(51) Int. Cl. G06Q 40/02; G06Q 20/14; G06Q 20/10; G06Q 20/32; G06Q 20/36

(52) U.S. Cl. CPC G06Q 40/025; G06Q 20/14; G06Q 20/108; G06Q 20/326; G06Q 20/3223; G06Q 20/367

(57) ABSTRACT

An integrative bill payment system for individuals and businesses where users and lenders can partner with each other and ensure no bill is left unpaid. The bill payment platform allows users to add bills through mobile app or desktop, add a credit lender and deposit funds into their account. Once bills are due, system will automatically make payment using user s balance first and if insufficient, utilize lender's credit to complete bill payment. Users have the option to apply for credit lending directly Into the platform and receive funding that is only used when user s own balance is 0. Users have the option not to deposit any funds and fully utilize extended credit for automatic bill payment for any period they like. They also can choose not to have a lender in their profile and make bill payments using their funds only. System has 3 interfaces: User Interface, Lender Interface, and Admin Interface. All interfaces are securely linked and automated to provide on time bill payments and instant deposits. Once bills become due, system generates a file that is automatically sent out for payment to service providers on users behalf. Users also have the preauthorized bill payment option, and funds are deducted on the day the bills are due. Lenders Interface allows credit lenders to review new applications, approve or deny users credit request. Once a lender approves an application, that user will automatically get funded from lender's account. All lenders see new applications as they become available and as it is in lender's discretion to approve or deny credit request, it is also on user's discretion to approve or deny the extended loan and choose only a lender that better suits their credit needs. User can deposit funds into their account or make a payment to the lender any time without any penalty. No monthly obligations are required from lenders, it is up to a user the amount and time they choose to pay back to their lender. However, annual interest rate that is set by lender will accrue on any amount that is used by user's account. Lender interface allows credit lender to see their approved users and modify any credit lending at their discretion.

Admin Interface allows for system to pool all user bills by due date and send automatic payment to service providers on users behalf. It also providers the option of approving users for an account, set membership type, whether it is business or personal, add lenders, add and manage service providers, review new and approved applications, see all bill payment history, and deposit transactions from lenders and users.

### SUMMARY OF INVENTION

An automatic bill payment platform where users and lenders can partner to ensure all bills (individual or business accounts) are paid on time and sufficient funds are available on user accounts.

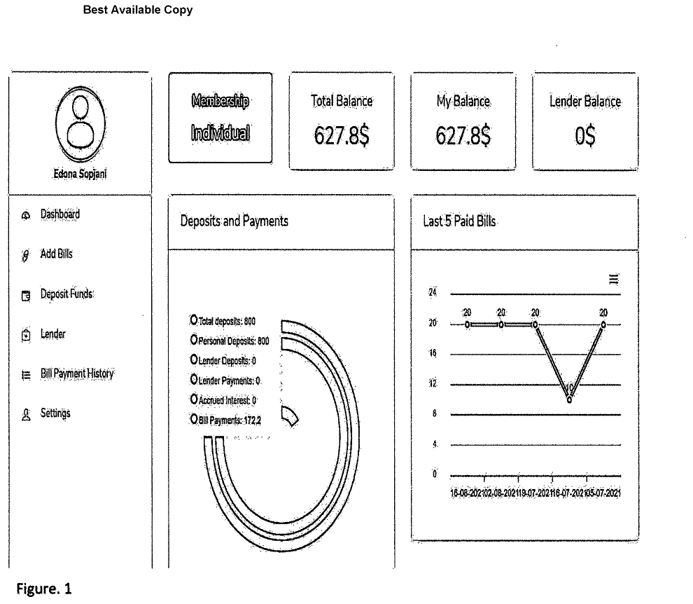

The system has 3 interfaces. 1) User Interface—as shown in FIG. 1 users can apply directly into their account for credit to be extended into their profile, add bills, set due dates, frequency and deposit funds using any electronic payment, such as debit, credit, interac e-transfer and crypto wallet. Bills that are due will be paid automatically from the system using users balance first and if insufficient, automatically utilizes lender's approved funds to cover any outstanding amounts. Users can make up to five credit applications within the system and if all five are rejected, users are setup to automatically wait a period of 90 days before they can make new lending application. As lenders will receive same applications, users also have a choice to approve or deny a lender for the same application. They can select a lender that has better interest rate and more lending flexibility. Users can sign up for an account themselves using the platform. User interface has: A) Dashboard; where platform users can see their balance, type of membership-whether it is individual or business, and lenders balance—if they have a line of credit. B) Add Bills; Users can add any bills and schedule them with payment frequency and due date. C) Deposit Funds; Users can deposit funds using credit, debit, interac e-transfer or crypto wallet payment. D) Lender; Users are able to see their approved lender information, line of credit amount, interest, payments-if any. Through lender tab, users that do not have any credit, can easily send an application to all platform lenders—using my application ticket. E) Bill Payment History; Users are able to see bill payment transactions, and filter them by their date of occurrence, service provider or alphabetical order.

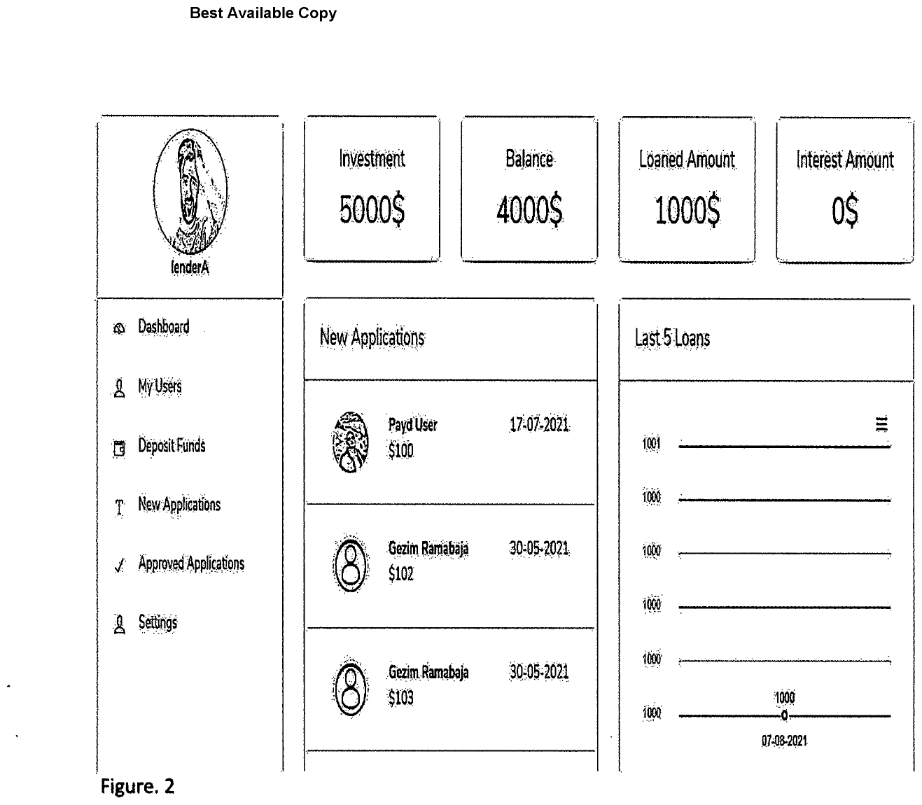

2) Lender Interface—As shown on FIG. 2, lenders can invest in users, such as individuals and businesses and allow the system to utilize their funds to cover bills that do not have sufficient user balance. Once a user applies into the system, lenders are able to see new applications (known as application pool) in their interface and based on information provided, approve, modify credit amount, or deny an application. Once an application is approved, funds get added to user s account instantly and subtracted from lenders account. Lender can see and monitor its approved users credit, see any incoming payment from the user into the lender and lend additional funds to new users or its approved users. Lenders will not be requiring monthly premiums or minimum payments from its users. They will charge annual interest amount that will accrue into their account. Platform users can decide, at their convenience to pay the (ender any amount they want at any time. Users can also pay lender's credit line entirely without any penalties. Lenders are registered and signed up by platform administrators. Lender interface is comprised of A) Dashboard; Where lenders can see total account balance, investment amount, users, and interest accrued from all lending verticals. B) My Users; In this tab, lenders can see all approved users, credit amount, interest charged for each user and date of transaction occurrences. C) Deposit Funds; Lenders can directly deposit funds into their account platform using any electronic payment, such as debit, credit, EFT, interac e transfer or a crypto wallet. Once deposit is approved, funds will automatically show Into lenders account. Then lender can decide, at their discretion, to invest funds in users they see financially fit. D) New Applications; Lenders can see all applications that have not reviewed or approved yet. Here lenders can review applications and make their decision whether to approve or deny an application. Once an application is denied, the application will no longer show in this particular lender tab but will still remain in the application pool for other lenders to review. E) Approved Applications; This tab allows lender to see all approved applications with amount and date of occurrence.

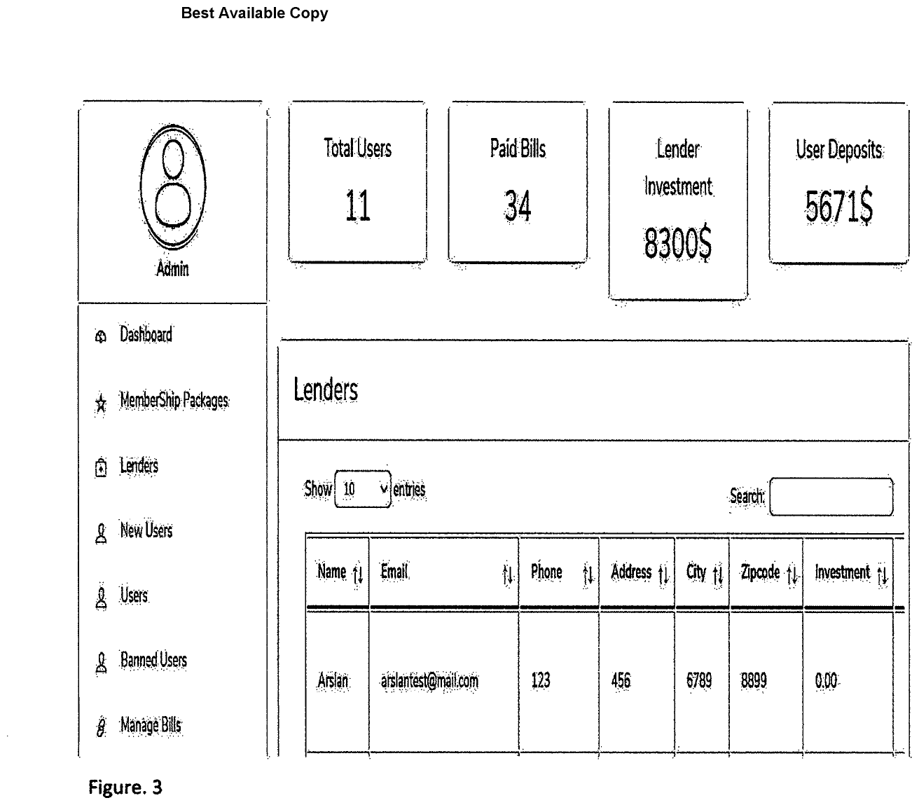

3) Admin Panel Interface—Technical description of interface functions are shown on FIG. 3. Platform administrators manage service providers, add lenders, automatically export list of due date bills, and pay them to the service providers on users behalf; review new credit applications, approved applications and rejected applications. Administration Interface also allows for fund transfer from users to lenders and vice versa. Admin panel interface has the following tabs; A) Dashboard; Where admin manager can see total platform users (individual and business combined), number of bills paid, total investment from lenders and total user balances. B) Membership packages; This tab shows all individual and business accounts, separated by the membership type. C) Lenders; This tab shows all platform lenders and their detail information. D) New Users; All new signed up users will show up in this tab. It is in the discretion of the platform admin to decide to approve or reject a user. This is a safety stop, to avoid bots and other mass phishing scam sign ups and approve only accounts that are valid. Users will not be able to use their profile until the account is approved by the platform administrator. E) Users; This tab shows all approved users. F) Manage Bills; This is where all bills that are added by users show up in order of username, account information, bill amount, service provider and status. G) Bill Payment History; All past historical bill payment transactions are pooled in this tab. H) Daily Payouts; This tab extracts all due date bills from all users and sends them for payment to service providers. I) Transactions; This tab shows all deposits made by user, lender and user to lender with user and amount details. J) New Applications;

All new user credit applications (application pool) is shown in this tab. K) Approved Applications; This tab shows all approved applications along with lenders that approved applications and users that received the funds. L) Cancelled Applications; Once five lenders cancel the same user, a credit application for that user is automatically canceled and will show up in this tab. User will not be able to make any new credit applications for a period of 90 days. M) Service Providers; In this tab, admin manager can add, modify or remove a service provider based on user demand. All added service providers will show up in users add bills tab where they can select them and schedule a bill for payment.

Summary of Invention contains no new matter.

We hereby claim:

1. An integrated desktop and mobile app bill payment system that partners users (business and individual accounts) with lenders through automated fund transfer, to ensure on time bill payment and sufficient account balances. Users have the ability to apply and receive lender funds automatically into their platform account for bill payment purposes. Users have no monthly obligations toward any lending that has been approved in their account. Users can choose to fund their account, and system will pull due date bills and make payments using user's balance first and if insufficient, utilize lender funds to complete bill payment process. Once users submit applications through the system, they pool in the new applications tab for all lenders to be able to review them. Lenders have the option to approve, modify or deny a credit request. Once lender approves a credit request, the approval amount automatically will transfer to users account. If lender denies an application, that user will no longer show for that lender but still be visible in the application pool for other lenders to review. Lender charges annual interest on used balances only. No monthly minimum payments or premiums will become due for users. Users and lenders can deposit funds into their account through electronic payment transfer (debit, credit, e transfer, interac and crypto wallet).

2. A bill payment system that utilizes users funds and remits payments to service providers on user's behalf. Users can add their bills by uploading a bill photo, schedule due dates and frequency. Afterwards, system will remit payments on users behalf to service providers based on due dates. Users can set preauthorized debit (PAD) with service providers and all bills will be paid according to frequency utilizing users funds in the account. System will remit payments using users funds first, and if insufficient, utilize lender credit to complete bill payment transactions. Users on preauthorized debit (PAD) have no monthly obligations to submit reoccurring bills. Service providers will automatically pull funds from platform based on bill frequency to cover bill charges for all users. Platform account holders that have lender attached to their profile, do not have any monthly financial obligations. They can deposit any amount they prefer and pay lender any time that is suitable for them. Users can decide to pay lender entire balance, close loan or pay a portion of the balance without any penalty. Once user makes a payment through the system towards the lender, funds will automatically be credited to user's lender account.

3. A bill payment system that has User, Lender and Administration interfaces all securely connected and automated. Each interface is capable of communicating with one another to ensure on time bill payment, credit approval, and fund transfer/deposits.
User Interface has A) Dashboard; where platform users can see their balance, type of membership—whether it is individual or business, and lenders balance—if they have a line of credit. B) Add Bills; Users can add any bills and schedule them with payment frequency and due date. C) Deposit Funds; Users can deposit funds using credit, debit, interac e-transfer or crypto wallet payment. D) Lender; Users are able to see their approved lender information, line of credit amount, interest, payments—if any. Through lender tab, users that do not have any credit, can easily send an application to all platform lenders—using my application ticket. E) Bill Payment History; Users are able to see bill payment transactions, and filter them by their date of occurrence, service provider or alphabetical order.
Lender interface has A) Dashboard; Where lenders can see total account balance, investment amount, users, and interest accrued from all lending verticals. B) My Users; In this tab, lenders can see all approved users, credit amount, interest charged for each user and date of transaction occurrences. C) Deposit Funds; Lenders can directly deposit funds into their account platform using any electronic payment, such as debit, credit, EFT, interac e transfer or a crypto wallet. Once deposit is approved, funds will automatically show into lenders account. Then lender can decide, at their discretion, to invest funds in users they see financially fit. D) New Applications; Lenders can see all applications that have not reviewed or approved yet. Here lenders can review applications and make their decision whether to approve or deny an application. Once an application is denied, the application will no longer show in this particular lender tab but will still remain in the application pool for other lenders to review. E) Approved Applications; This tab allows lender to see all approved applications with amount and date of occurrence.
Administration Interface has A) Dashboard; Where admin manager can see total platform users (individual and business combined), number of bills paid, total investment from lenders and total user balances. B) Membership packages; This tab shows all individual and business accounts, separated by the membership type. C) Lenders; This tab shows all platform lenders and their detail information. D) New Users; All new signed up users will show up in this tab. It is in the discretion of the platform admin to decide to approve or reject a user. This is a safety stop, to avoid bots and other mass phishing scam sign ups and approve only accounts that are valid. Users will not be able to use their profile until the account is approved by the platform administrator. E) Users; This tab shows all approved users. F) Manage Bills; This is where all bills that are added by users show up in order of username, account information, bill amount, service provider and status. G) Bill Payment History; All past historical bill payment transactions are pooled in this tab. H) Daily Payouts; This tab extracts all due date bills from all users and sends them for payment to service providers. I) Transactions; This tab shows all deposits made by user, lender and user to lender with user and amount details. J) New Applications; All new user credit applications (application pool) is shown in this tab. K) Approved Applications; This tab shows all approved applications along with lenders that approved applications and users that received the funds. L) Cancelled Applications; Once five lenders cancel the same user, a credit application for that user is automatically canceled and will show up in this tab. User will not be able to make any new credit applications for a period of 90 days. M) Service Providers; In this tab, admin manager can add, modify or remove a service provider based on user demand. All added service providers will show up in users add bills tab where they can select them and schedule a bill for payment.
